(19) United States
(12) Patent Application Publication
(10) Pub. No.: US 2009/0306265 A1
(43) Pub. Date: Dec. 10, 2009

(54) PRODUCTION OF COMPOSITES MADE OF POLYOXADIAZOLE POLYMERS

(75) Inventors: Dominique De Figueiredo Gomes, Apsen (DE); Marcio Rodrigo Loos, Blumenau (BR); Julio Albuerne, Hamburg (DE)

Correspondence Address: MICHAUD-DUFFY GROUP LLP, 306 INDUSTRIAL PARK ROAD, SUITE 206, MIDDLETOWN, CT, 06457, US

(73) Assignee: GKSS-Forschungszentrum Geesthacht GmbH, Geesthacht (DE)

(21) Appl. No.: 12/480,095

(22) Filed: Jun. 8, 2009

(30) Foreign Application Priority Data
Jun. 10, 2008 (DE) 102008027499.2

(51) Int. Cl. C08K 3/32

(52) U.S. Cl. 524/415; 524/417

(57) ABSTRACT

Polyoxadiazole composites are produced by heating a mixture of a filler in polyphosphoric acid to functionalize the filler. A hydrazine component and a dicarboxylic acid component are added to the mixture to form a solution, and the solution is heated to form a polyoxadiazole composite. The polyoxadiazole composite is precipitated from the solution.

### CROSS-REFERENCE TO RELATED APPLICATION

This application claims the benefit of German patent application number DE 10 2008 027 499.2, dated Jun. 10, 2008, the contents of which are incorporated herein in their entirety.

### FIELD OF THE INVENTION

The invention relates to a method for the production of polyoxadiazole composites made of polyoxadiazole homopolymers and/or copolymers. Moreover, the invention relates to polyoxadiazole composites and the use of polyoxadiazole composites.

### BACKGROUND

Polyoxadiazoles have high glass transition temperatures in addition to high chemical and thermal stability. They can be processed directly, e.g. be spun into fibers, or coatings can be created out of them.

Polyoxadiazoles are synthesized in various solvents. A known example is the synthesis of oleum, fuming sulfuric acid, as a solvent. Oleum represents a very toxic and corrosive synthesis environment. An excessive neutralization of the medium is required after the end of the synthesis reaction. The synthesis of polyoxadiazole in oleum is described for example in DD 292 919 A5 and DE 24 08 426 C2.

For example, there is a need for high performance polymers or polymer materials in the airline industry. Thermoplastic polyoxadiazole polymers in particular have great potential as a construction material due to their mechanical properties. For this, it was suggested in U.S. Pat. No. 5,118,781 to synthesize poly(1,3,4-oxadiazole) through an aromatic nucleophilic displacement reaction of dihydroxyl vinyl monomers with aromatic dihalogens or aromatic dinitro compounds. The polymerizations took place in polar, aprotic solutions such as for example sulfonlanes or diphenol sulfones using alkali metal bases such as for example potassium carbonate at increased temperatures.

Moreover, polyoxadiazole composites were created through the addition of fillers (F. G. Souza et al., Journal of Applied Polymer Science 2004, 93, 1631-1637; M. Loos et al. Proceedings of the Eurofillers, Hungary (Zalakaros), 2007, 119-120; D. Gomes et al., Journal of Membrane Science (2008) doi: 10.1016/j. memsci. 2007.11.041). Moreover, it was described in US 2008/0014440 A1 that polyoxadiazoles are created through the addition of a flexible chain of non-polyoxadiazole polymers into the polyoxadiazole matrix.

In the article from F. G. Souza et al. (Journal of Applied Polymer Science 2004, 93, 1631-1637), conductive polyoxazoldiazole composites were described through dispersion of carbon black in polyoxadiazole solutions in NMP (N-methyl-2-pyrrolidone). Since the fillers were not functionalized, agglomerates were observed. Moreover, the composites with a higher share of carbon black exhibited a higher heterogeneous morphology with irregular breaks. It was shown that the heterogeneity has strong impacts on the stability of the film.

In order to prevent the formation of agglomerates, it was suggested by M. Loos et al. (Proceedings of the Eurofillers, Hungary (Zalakaros), 2007, 119-120) to first functionalize the fillers. For this, nanocomposites were created in two stages. Carbon nano tubes (CNT) were first oxidized in a polyphosphoric acid. The functionalized carbon nano tubes with hydroxyl and carboxyl groups were then added to a polyoxadiazole matrix, which was synthesized in another reaction process or batch process.

Moreover, D. Gomes et al. (Journal of Membrane Science (2008) doi: 10.1016/j. memsci. 2007.11.041) described that polyoxadiazole was functionalized with functionalized silicon dioxide particles. The composites were produced in two stages. The monomers and the silicon dioxide particles were first functionalized over several days, as described by D. Gomes et al. in J. Polym. Sci. Part B: Polym. Phys. 2006, 44, 2278-2298. The functionalized fillers were then added to a polyoxadiazole matrix, which was synthesized in another reaction process.

Moreover, Baek et al. (in Macromolecules 2004, 37, 8278-8285), S.-J. Oh et al. (in Polymer 2006, 47, 1132-1140) and D. H. Wang et al. (in Chem. Mater. 2008, 20, 1502-1515) described polymer(ether ketone) composites, which were produced via an in-situ synthesis process of A-B monomers in polyphosphoric acid. Baek et al. (in Macromolecules 2004, 37, 8278-8285) hereby showed that the synthesized composites have a higher solubility in strong acids than in conventional organic solutions. Oh et al. (Polymer 2006, 47, 1132-1140) introduced composites that were produced through the grafting of polyether ketones on multi-walled carbon nano tubes through an in-situ polycondensation of A-B monomers.

Wang et al. (Chem. Mater. 2008, 20, 1502-1515) also described hyperbranched poly(ether ketone) composites, which have a better solubility, e.g. in aprotic polar solvents.

Based on this state of the art, the object of the present invention is to provide polyoxadiazole polymers that are easy to produce, wherein the polyoxadiazole polymers should have a resistance at high temperatures.

### SUMMARY OF THE INVENTION

The present invention resides in one aspect in a method for the production of polyoxadiazole composites. The method is carried out by heating a mixture comprising a filler in polyphosphoric acid to functionalize the filler. A hydrazine component and at least one dicarboxylic acid component are added to the mixture to form a solution, and the solution is heated to form a polyoxadiazole composite. The polyoxadiazole composite is precipitated from the solution.

### BRIEF DESCRIPTION OF THE DRAWINGS

FIG. 1 is a diagram indicating the average molecular weight of fluorinated polyoxadiazole composites as a function of the reaction time.

FIG. 2a is a scanning electron microscope image of a comparative fluorinated polyoxadiazoles prepared according to the prior art.

FIG. 2b is a scanning electron microscope image of fluorinated polyoxadiazole composites according to the invention,

FIG. 3a is a graph showing a Raman spectrum of carbon nano tubes (CNT).

FIG. 3b is a graph showing a Raman spectrum of polyoxadiazole composites according to the invention with 10 wt. %.

FIG. 4 is a scanning electron microscope image of a polyoxadiazole composite film with a wt. % of carbon nano tubes (CNT).

FIG. 5 is a diagram of dynamic mechanical thermal analysis (DMTA) of polyoxadiazole composite films.

### DETAILED DESCRIPTION

A method is described herein for producing polyoxadiazole composites which contain polyoxadiazole homopolymers and/or copolymers and a filler. The polyoxadiazole composites are formed by carrying out a polycondensation reaction of a hydrazine component and a dicarboxylic acid component in polyphosphoric acid. The hydrazine component may comprise hydrazine and/or its derivates monomers, and the dicarboxylic acid component may comprise dicarboxylic acid and/or its derivates. The filler is functionalized in the polyphosphoric acid through heating of the mixture.

In one embodiment, the polycondensation reaction is a direct polycondensation reaction, although the invention is not limited in this regard. Optionally, the filler may be functionalized under a gas atmosphere, although the invention is not limited in this regard. In another optional aspect, the solution formed by the addition of the hydrazine component to the mixture of filler and polyphosphoric acid may be heated under an inert atmosphere, although the invention is not limited in this regard.

In one embodiment, a method for the production of polyoxadiazole composites made of polyoxadiazole homopolymers and/or copolymers by means of a, preferably direct, polycondensation reaction of A-A (hydrazine and/or its derivates) monomers and B-B (dicarboxylic acid and/or its derivates) monomers with a filler in polyphosphoric acid, wherein the following steps are executed:
a) the filler is functionalized in the polyphosphoric acid through heating of the mixture, preferably under a gas atmosphere,
b) hydrazine and/or its derivates and at least one dicarboxylic acid and/or its derivates are mixed with the mixture from process step a) into a solution,
c) the solution from process step b) is heated, preferably under an inert atmosphere, and
d) the polyoxadiazole composites are precipitated in a solution and in particular neutralized.

Through the polyoxadiazole composites according to the invention, polyoxadiazole polymers are produced in a single-stage, in-situ polycondensation reaction, wherein the polyoxadiazole polymers have improved mechanical properties. Composites are hereby produced, which are then integrated in conductive, thermally and chemically stable membranes.

The heating of the polyphosphoric acid or the mixture in process step a) takes place advantageously under a gas atmosphere, in particular an atmosphere of nitrogen and/or argon with or without water.

Moreover, fibers or films can be produced from the polyoxadiazole composites used in separation processes or in membrane separation processes, respectively. Moreover, the polyoxadiazole composites produced according to the invention can be used as reinforcing agents, for the production of sensors, electrodes or for coatings and lightweight construction materials.

The production of the polyoxadiazole composites takes place by means of a fast in-site synthesis process, wherein the produced polyoxadiazoles had a high (average) molecular weight of about 200,000 to about 424,000 Daltons (Da). The polyoxadiazoles are hereby soluble in organic solvents, which then show good thermal and mechanical properties as density films without filler agglomeration. For example, the created polyoxadiazole polymers or composites have a high elasticity module or storage module of up to about 6 GPa at 150° C.

Based on the fact that the fillers are functionalized with the polyoxadiazole chains, a better dispersion of the fillers in the polyoxadiazole matrix results since the fillers are functionalized with the polyoxadiazole chains. The method is also characterized by a short or shorter method duration, since the functionalization of the fillers and the synthesis of the polyoxadiazoles takes place in a reaction process or batch process.

The heating of the mixture in process step a) is preferably executed at a temperature of about 25° C. to about 200° C., optionally up to about 180° C., for example, about 160° C. to about 180° C. The filler of the mixture is hereby functionalized in the polyphosphoric acid.

Moreover, the heating of the solution in process step c) is preferably executed at a temperature of about 100° C. to about 200° C., optionally up to about 180° C., for example, about 160° C. to about 180° C. Moreover, the heating of the solution in process step c) is executed for a duration of up to about 48 hours, for example about 3 hours to about 48 hours, and in one embodiment, about 3 to about 16 hours. This results in a faster method duration for the production of polyoxadiazole polymers or composites, respectively.

It is also provided in a preferred configuration that hydrazine in the form of hydrazine salt, in particular hydrazine sulfate salt, is admixed in process step b).

Moreover, it is beneficial if dicarboxylic acid in the form of dicarboxylic acids with two carboxylic acid groups, preferably aromatic and/or heteroaromatic dicarboxylic acids, and/or their derivates are admixed in process step b).

Within the scope of the invention, it is possible that dicarboxylic acid is also added in the form of dicarboxylic acid diester or dicarboxylic acid/dicarboxylic acid diester mixtures in process step b).

The filler is preferably made of carbon nano tubes (CNT) and/or molecular-sieving carbon and/or graphite and/or pyrolized polymer particles and/or inorganic particles and/or silicon dioxide (silica) and/or aluminum oxide (clay) and/or titanium and/or montmorillonite and/or silicates and/or fullerenes and/or zeolite and/or aluminum oxide and/or zinc oxide and/or polymer fibers and/or glass fibers.

Moreover, the mixture, in particular in process step a), may optionally contain one or more additives, cross-linking agents, softeners, expanding agents, lubricants, surfactants, texturants, colorants, pigments, glimmer, flame retardants, stabilizers, reinforcing fibers, adhesion promoters and/or mixtures of these. The produced polyoxadiazole composites are hereby assembled according to the requirements for a provided application, e.g. in components or in devices.

In the case of the method according to the invention, the polyoxadiazole has one polymer with at least one conjugated ring with two nitrogen atoms and one oxygen atom, wherein in particular the polymer has a repetition element of the structure

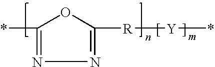

wherein Y is a group with the structure

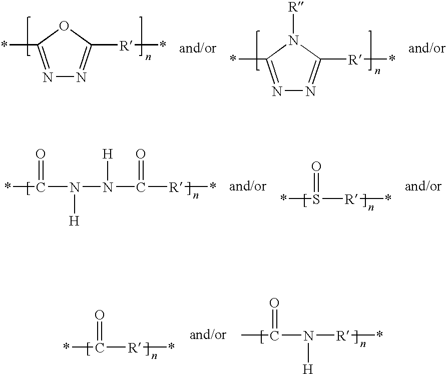

wherein R and R′ are each groups with 1 to about 40 carbon atoms and R″ is a hydrogen atom or a group with 1 to about 40 carbon atoms, wherein n and m are natural whole numbers, which are each greater than zero.

Moreover, it is provided in one embodiment that the polyoxadiazole mixture with the composites, in particular according to process step c), is dissolved in a solvent, wherein a film or a fiber is poured or formed out of this, in particular in a further process step.

Moreover, in a preferred process step, the polyoxadiazole composites are dissolved in a solution and are processed before they are poured into a film or formed into a fiber using a calender, preferably with three rollers, and or a mixer.

The polyoxadiazole composites are preferably melted before they are poured into a film or formed into a fiber.

Moreover, the object is solved through polyoxadiazole composites, which can be obtained through the execution of the named process steps. We expressly refer to the above explanations in order to avoid repetitions. Moreover, the polyoxadiazole composites are characterized in that the composites have a tensile strength of up to 6 GPa, preferable at 150° C.

The polyoxadiazole composites preferably have a molecular weight of at least about 200,000 Daltons. In the case of the polyoxadiazole composites produced according to the invention, average molecular weights of at least 200,000 Daltons (Da) to about 424,000 Daltons (Da) were measured.

Furthermore, the object is solved through the use of polyoxadiazole composites, which are produced according to the method described above, for the production of a membrane or a fiber or a film or as a reinforcing agent or for the production of sensors or electrodes or as a coating and lightweight construction material.

The invention is described below, without restricting the general intent of the invention, based on exemplary embodiments in reference to the drawings, whereby we expressly refer to the drawings with regard to the disclosure of all details according to the invention that are not explained in greater detail in the text.

### EXAMPLE 1

### Synthesis of Fluorinated Polyoxadiazole Composites

Polyphosphoric acid (PPA) is first added to a flask and heated to 60° C. in a dry nitrogen atmosphere. Carbon nano tubes (CNT) are then added to the polyphosphoric acid as a filler and are homogenized at 160° C. through stirring and heating. After 3 hours of functionalization of the carbon nano tubes, hydrazine sulfate salt (HS, >99%, Aldrich) is added to the mixture. After the hydrazine sulfate salt is dissolved, 4,4′-dicarboxylphenyl hexafluoropropane (HF, 99%, Aldrich) is added.

The molar thinning ratio (PPA/HS) and the molar monomer rate (HS/HF) were held constant, and were 10 and 1.2, respectively.

After reaction periods of 3 to 48 hours, the reaction medium was added to water with 5 wt. % of sodium hydroxide (99%, Vetech) for precipitation of the polymer. The pH value of the polymer suspension was hereby checked, as described in the literature (Gomes et al., Polymer 2004, 45, 4997-5004).

The polyoxadiazole composites obtained with a yield of 97% are soluble in the solvents NMP (N-methyl-2-pyrrolidone) and DMSO (dimethyl sulfoxide). The average molecular weight of the composites was determined by means of size exclusion chromatography (SEC) in the range of 200,000 to 280,000 Da with a yield of 97 to 99%. A chromatograph from Viscotek with Eurogel separation columns SEC 10,000 and PSS grams 100, 1000 with the series numbers HC286 and 1515161 and a size of 8×300 mm was used for this in order to determine the average molecular weight of the polymer samples.

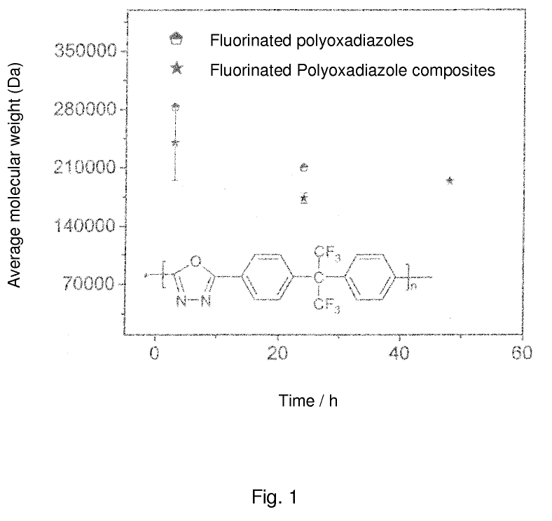

The device was calibrated using polystyrene standards (Merck) with an average molecular weight between 309 to 944,000 grams per mole (g/Mol). A solution with 0.05 molar (M) lithium bromide in DMAc (dimethylacetamide) was used as the carrier. Solutions with 0.5 wt. % of the polyoxadiazole composites were prepared filtered (0.2 μm) and injected in the chromatographs. The results are set forth in FIG. 1

As can be seen in FIG. 1, a high molecular weight was already achieved after a reaction time of 3 hours.

### Scanning Electron Microscope Analysis

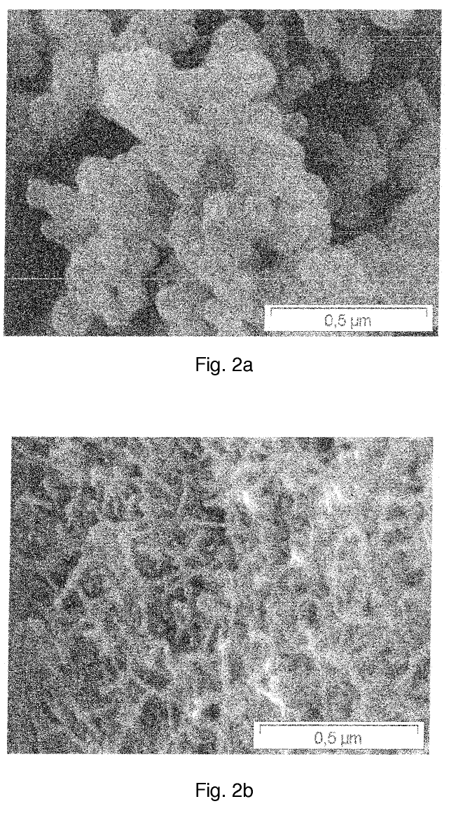

The morphology of the polyoxadiazole composites was examined with a scanning electron microscope of type LEO 1550VP after the samples were coated (or “sputtered”) with gold in a sputter device. The structure of fluorinated polyoxadiazoles prepared according to the prior art (FIG. 2a) and the polyoxadiazole composites produced according to the invention (FIG. 2b) can be seen in the scanning electron microscope images.

It can be seen in the two images that the original structure of the highly hydrophobic, fluorinated polyoxadiazole (FIG. 2a) was reduced or lost as a result of the grafting of the polymers onto the surface of the carbon nano tubes (CNT).

### EXAMPLE 2

### Synthesis of Polyoxadiazole Composites

Polyphosphoric acid (PPA) was first added to a flask and heated to 60° C. in a dry nitrogen atmosphere. The carbon nano tubes (CNT) were then added to the polyphosphoric acid and homogenized at 160° C. through stirring and heating. After one hour of functionalization of the carbon nano tubes, hydrazine sulfate salt HS (>99%, Aldrich) was added to the mixture. Dicarboxyl diazide-4,4′-diphenyl ether (DPE, 99%, Aldrich) was then added after dissolution of the hydrazine sulfate salt.

The molar thinning ratio (PPA/HS) and the molar monomer rate (HS/DPE) were held constant at 10 and 1.2, respectively. After a reaction period of 3 hours, the reaction medium was added to water with 5 wt. % sodium hydroxide (99%, Vetech) for precipitation of the polymer. The pH value of this polymer suspension was checked according to the known method (Gomes et al. Polymer 2004, 45, 4997-5004).

The polyoxadiazole composites, which are soluble in the solvents NMP and DMSO, were obtained with a yield of 97%. The average molecular weight of the composite was determined through SEC to be 424,000 Da.

### Raman Spectroscopy

Raman spectrums of the polymer samples were then recorded. The Raman spectrums were hereby recorded on an FT Raman module RAMII using a Nd:YAG laser excited at 1,064 nm (nanometers).

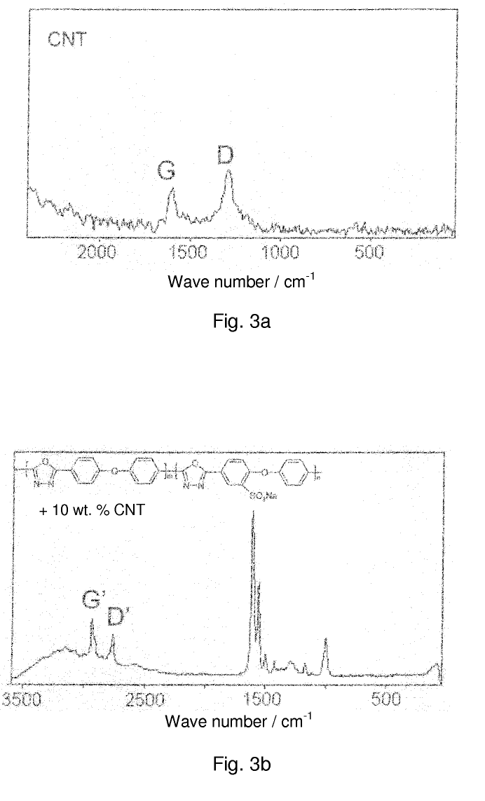

FIG. 3a shows the Raman spectrum of carbon nano tubes (CNT) and FIG. 3b the Raman spectrum of polyoxadiazole composites with 10 wt. % CNT.

As can be seen in FIG. 3a, the D and G bands of the carbon nano tubes were observed at approx. 1,300 cm⁻¹ and 1,600 cm⁻¹, which can both be attributed to defects and modes of graphics, both for the (original) carbon nano tubes (FIG. 3a) and for the polyoxadiazole composite (FIG. 3b).

After the functionalization of the carbon nano tubes with polyoxadiazole (FIG. 3b), bands were observed at 1,613 cm⁻¹, 1,506 cm⁻¹, 1,290 cm⁻¹, 1,168 cm⁻¹ and 997 cm⁻¹, which can be attributed to the aromatic groups in the main chains of the polyoxadiazole. One band at 1,497 cm⁻¹ was also observed based on the oxadiazole ring. Moreover, the bands of the 2^{nd} order G′ and D′ for the carbon nano tubes at 2,940 cm⁻¹ or at 2,760 cm⁻¹ (FIG. 3b) also appeared.

### EXAMPLE 3

### Film Preparation

Homogenous films made of the polyoxadiazole composite solutions with a concentration of 4 wt. % were poured into DMSO. After the pouring, DMSO was evaporated in a vacuum furnace at 60° C. for a period of 24 hours. For the removal of other remaining solvents, the films were immersed into a water bath for 48 hours at 50° C. and then dried in a vacuum furnace for 24 hours at 60° C. The final thickness of the films was approximately 70 μm.

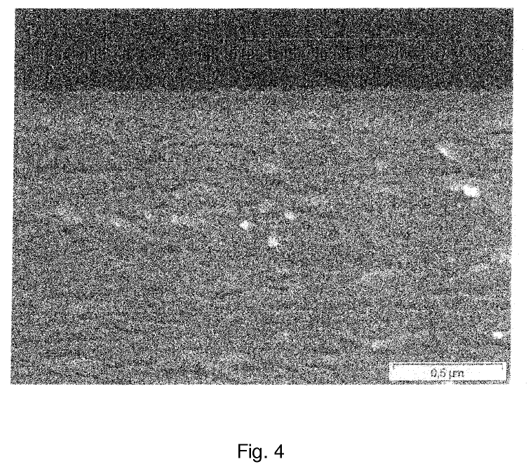

FIG. 4 shows a scanning electron microscope image of a dense polyoxadiazole composite film with 1 wt. % CNT without agglomerates.

### Thermal and Mechanical Analysis

The dynamic mechanical thermal analysis (DMTA) was used to determine the storage module. The DMT analysis was executed using a TA Instrument RSA II with a film tensioning mode at a frequency of 1 Hz and an initial static force of 0.1 N. The temperature was changed from 150° C. to 500° C. with a heating rate of 2°/min and a constant tension of 0.05%.

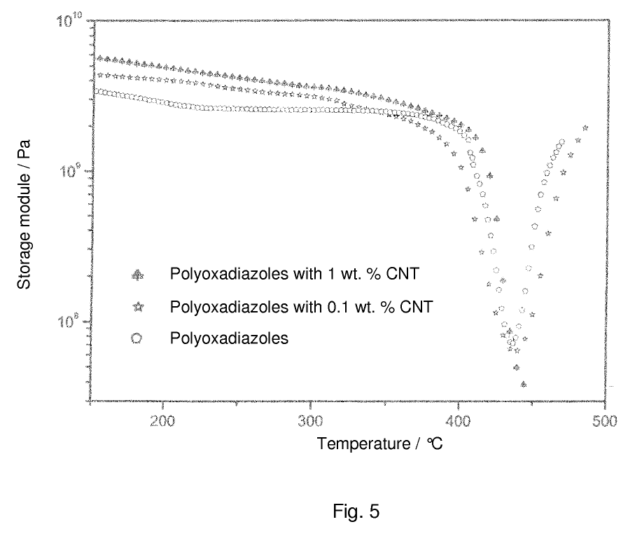

FIG. 5 shows the graphs of the DMT analysis of the original polyoxadiazole and of polyoxadiazole composites with 0.1 wt. % CNT and 1 wt. % CNT. The graph in FIG. 5 clearly shows the good stability of the polyoxadizole composite films and the high storage module for this polyoxadiazole composite with a high concentration (1 wt. % CNT) is approximately 6 GPa (Giga-Pascals) at 150° C.

Where a ratio of two parameters (e.g., A/B) is reported as a single value, e.g., a ratio of A/B=X, it is to be understood that the ratio referred to is proportion of the stated single value to 1, i.e., X:1.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A method for the production of polyoxadiazole composites, comprising:
a) heating a mixture comprising a filler in polyphosphoric acid to functionalize the filler;
b) mixing a hydrazine component and at least one dicarboxylic acid component with the mixture from process step a) into a solution,
c) heating the solution from process step b) to form a polyoxadiazole composite; and
d) precipitating the polyoxadiazole composite.

2. The method according to claim 1, characterized in that the heating of the mixture in process step a) is executed at a temperature of about 25° C. to about 200° C.

3. The method according to claim 1, characterized in that the heating of the solution in process step c) is executed at a temperature of about 100° C. to about 200° C.

4. The method according claim 1, characterized in that the heating of the solution in process step c) is executed for a duration of up to about 48 hours.

5. The method according to claim 1, characterized in that hydrazine in the form of hydrazine salt.

6. The method according to claim 1, characterized in that the dicarboxylic acid component comprises dicarboxylic acids with two carboxylic groups.

7. The method according to claim 1, characterized in that the filler is made of carbon nano tubes (CNT) and/or molecular-sieving carbon and/or graphite and/or pyrolized polymer particles and/or inorganic particles and/or silicon and/or aluminum and/or titanium and/or montmorillonite and/or silicates and/or fullerenes and/or zeolite and/or aluminum oxide and/or zinc oxide and/or polymer fibers and/or glass fibers.

8. The method according to claim 1, characterized in that the mixture also contains additives, cross-linking agents, softeners, expanding agents, lubricants, surfactants, texturants, colorants, pigments, glimmer, flame retardants, stabilizers, reinforcing fibers, adhesion promoters and/or mixtures of these.

9. The method according to one of claim 1, characterized in that the polyoxadiazole has a repetition element of the structure 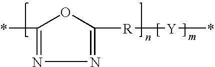
wherein Y is a group with the structure 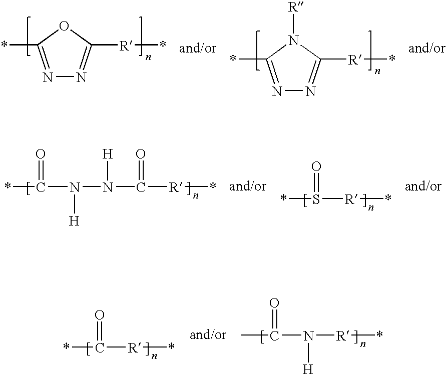
e) wherein R and R′ are each groups with 1 to about 40 carbon atoms and R″ is a hydrogen atom or a group with 1 to about 40 carbon atoms, wherein n and m are natural whole numbers, which are each greater than zero.

10. The method according to claim 1, characterized in that the polyoxadiazole mixture is dissolved in a solvent, wherein a film or a fiber is poured or formed, in particular in a further process step.

11. The method according to claim 1, wherein the polyoxadiazole composites are dissolved in a solution and processed before they are poured into a film or formed into a fiber.

12. The method according to claim 1, characterized in that the polyoxadiazole composites are melted before they are poured into a film or formed into a fiber.

13. The method according to claim 1, characterized by heating the mixture formed in step (a) under a gas atmosphere.

14. The method according to claim 1, wherein the solution from step (b) is heated under an inert atmosphere.

15. The method according to claim 1, wherein precipitating the polyoxadiazole composite comprises neutralizing the solution.

16. Polyoxadiazole composites obtained from the process steps according to claim 1.

17. The polyoxadiazole composite according to claim 16, characterized in that the composition has a tensile strength of up to 6 GPa, preferably 150° C., and/or that the composites have a molecular weight of at least 200,000 Daltons (Da).

18. The use of polyoxadiazole composite, which are produced according to claim 1, for the production of a membrane or a fiber or a film or as a reinforcing agent or for the production of sensors or electrodes or as a coating and lightweight construction material.
